(19) United States
(12) Patent Application Publication
(10) Pub. No.: US 2026/0168288 A1
(43) Pub. Date: Jun. 18, 2026

(54) MOTORIZED DOOR LEVER TRIM ASSEMBLY

(71) Applicant: Securitech Group, Inc., Maspeth, NY (US)

(72) Inventors: Mark J. Berger, New York, NY (US); Nicholas Johnson, Flushing, NY (US); David Mate, Maspeth, NY (US); Jan Rupa, Ozone Park, NY (US); Krzysztof F. Marciniec, Glendale, NY (US)

(73) Assignee: Securitech Group, Inc., Maspeth, NY (US)

(21) Appl. No.: 19/389,181

(22) Filed: Nov. 14, 2025

Related U.S. Application Data
(60) Provisional application No. 63/734,266, filed on Dec. 16, 2024.

(51) Int. Cl. E05B 47/00

(52) U.S. Cl. CPC E05B 47/0012; E05B 2047/002; E05B 2047/0084

(57) ABSTRACT

Disclosed embodiments relate to motorized lever trim assemblies for door lock systems. Such a lever trim assembly may include a motor operatively coupled to a key cylinder spindle. The lever trim assembly may also include a key cylinder adapter configured to be received into a key cylinder slot of a lock body, and operatively couple the key cylinder spindle to a key cylinder linkage in the lock body.

### FIELD

The field relates to door lever assemblies for door lock systems, and specifically to motorized door lever assemblies.

### BACKGROUND

Door lock systems often include lock bodies including both latches and deadbolts. Conventional lock bodies generally include a latch spindle slot configured to receive a latch spindle of a lever trim assembly, and a deadbolt spindle slot configured to receive a deadbolt spindle of a lever trim assembly. The latch spindle is typically configured to attach to a handle, such that rotating the handle about a first lock axis rotates the latch spindle about the first lock axis. The deadbolt spindle is typically configured to attach to a thumb-turn, such that rotating the thumb-turn about a second lock axis rotates the deadbolt spindle about the second lock axis.

When the latch spindle is inserted into the lock body via the latch spindle slot, the latch spindle engages with a latch linkage which operatively couples the handle to the latch, such that rotating the handle about the first lock axis actuates (e.g. extends or retracts) the latch. When the deadbolt spindle is inserted into the lock body via the deadbolt spindle slot, the deadbolt spindle engages with a deadbolt linkage which operatively couples the thumb-turn to the deadbolt, such that rotating the thumb-turn about the second lock axis actuates (e.g. extends or retracts) the deadbolt.

Some lock bodies of door lock systems, such as a lock body offered by Securitech Group Inc. in their 7000 series door lock systems, also include a key cylinder slot configured to receive a conventional key cylinder, and a key cylinder linkage operatively coupled to both the deadbolt and the latch. In such configurations, actuation of such a conventional key cylinder may extend and retract both the latch and the deadbolt.

### SUMMARY

According to some embodiments, a lever trim assembly configured to couple to a lock body of a door lock system is provided. Such a lock body comprises a latch and/or a deadbolt, a key cylinder slot configured to receive a key cylinder, and a key cylinder linkage configured to operatively couple at least one of the latch and/or deadbolt to such a key cylinder. The lever trim assembly comprises a key cylinder spindle, a key cylinder adapter configured to be received into the key cylinder slot and operatively couple the key cylinder spindle to the key cylinder linkage, a bevel gear system operatively coupled to the key cylinder spindle, a motor operatively coupled to the bevel gear system to drive the key cylinder spindle, and a controller configured to control the motor to actuate the bevel gear system, the key cylinder spindle, the key cylinder adapter, and the key cylinder linkage to extend or retract the at least one of the latch and/or the deadbolt.

According to some embodiments, a door lock system is provided. The door lock system comprises a lock body comprising a latch and/or a deadbolt, a key cylinder slot configured to receive a key cylinder, and a key cylinder linkage configured to operatively couple at least one of the latch and/or deadbolt to such a key cylinder. The door lock system also comprises a lever trim assembly configured to couple to the lock body. The lever trim assembly comprises a key cylinder spindle, a key cylinder adapter configured to be received into the key cylinder slot and operatively couple the key cylinder spindle to the key cylinder linkage, a bevel gear system operatively coupled to the key cylinder spindle, a motor operatively coupled to the bevel gear system to drive the key cylinder spindle, and a controller configured to control the motor to actuate the bevel gear system, the key cylinder spindle, the key cylinder adapter, and the key cylinder linkage to extend or retract the at least one of the latch and/or the deadbolt.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 shows a front perspective view of a lever trim assembly coupled to a lock body of a door lock system according to an embodiment;

FIG. 2 shows an exploded front perspective view of the lever trim assembly and lock body of FIG. 1;

FIG. 3 shows an exploded rear perspective view of the lever trim assembly and lock body of FIG. 1;

FIG. 4A shows a front perspective view of a key cylinder adapter with components in a first orientation according to an embodiment;

FIG. 4B shows a front perspective view of the key cylinder adapter of the embodiment of FIG. 4A with components in a second orientation;

FIG. 5A shows a rear perspective view of the key cylinder adapter of the embodiment of FIG. 4A with components in the first orientation; and

FIG. 5B shows a rear perspective view of the key cylinder adapter of the embodiment of FIG. 4A with components in the second orientation.

### DETAILED DESCRIPTION

The inventors have recognized that it is often desirable to motorize the latch(es) and/or deadbolt(s) of conventional lock bodies, such that the latch(es) and/or deadbolt(s) may be electromechanically actuated. Such configurations may allow for improved security and convenience when unlocking and operating doors. For instance, such configurations may allow for a greater variety of entry options (e.g. biometrics, RFID, passcode, etc.).

One challenge with motorizing such latches and/or deadbolts is that the lock bodies themselves typically have limited space available inside, so fitting the motor(s) inside the lock body may prove difficult. It may therefore be desirable to position the motor components outside of the lock body, such as inside one of the lever trim assemblies of the door lock system. Such a configuration may provide sufficient space for the motor components to be properly integrated. Additionally, such a configuration may allow for converting already available door lock systems into such motorized lock systems simply by replacing the lever trim assemblies.

Conventional motorized lever trim assemblies generally couple the motor to the deadbolt spindle, and insert the deadbolt spindle into the deadbolt spindle slot in order to couple the motor to the deadbolt. However, such conventional motorized lever trim assemblies have several drawbacks when used with the above referenced lock bodies. Because the motorized spindle is inserted into the deadbolt spindle slot and connected to the deadbolt linkage, the motor can only be used to retract the deadbolt. In such a configuration, a user must still manually operate the handle of the lever trim assembly in order to retract the latch and open the door. Such a configuration may be undesirable to many user. For instance, such a configuration limits the viability of motorized door openers since the door may not be opened until the latch is manually retracted by the user, negating many of the advantages of automatically retracting the deadbolt in the first place.

Of course, the lever trim assembly may also include an additional motor coupled to the latch spindle, but such a configuration would increase the cost of production of the lever trim assembly, the electrical power requirements of the motorized lever trim assembly, and potentially increase the “bulkiness” of the lever trim assembly, leading to less desirable aesthetics.

The inventors have therefore recognized an advantage to a lever trim assembly configured to mount to the interior/secured side of the door which includes a motor coupled to a key cylinder spindle which is configured to operatively couple with the key cylinder linkage (e.g. via a key cylinder adapter) instead of the deadbolt linkage. In this manner, the key cylinder spindle and key cylinder adapter essentially replace the conventional lock cylinder on the interior side of the door. As a result, when such a lever trim assembly is coupled to a lock body which includes a key cylinder linkage operatively coupled to both the latch and the deadbolt, a single motor may be used to operate both the deadbolt and the latch.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

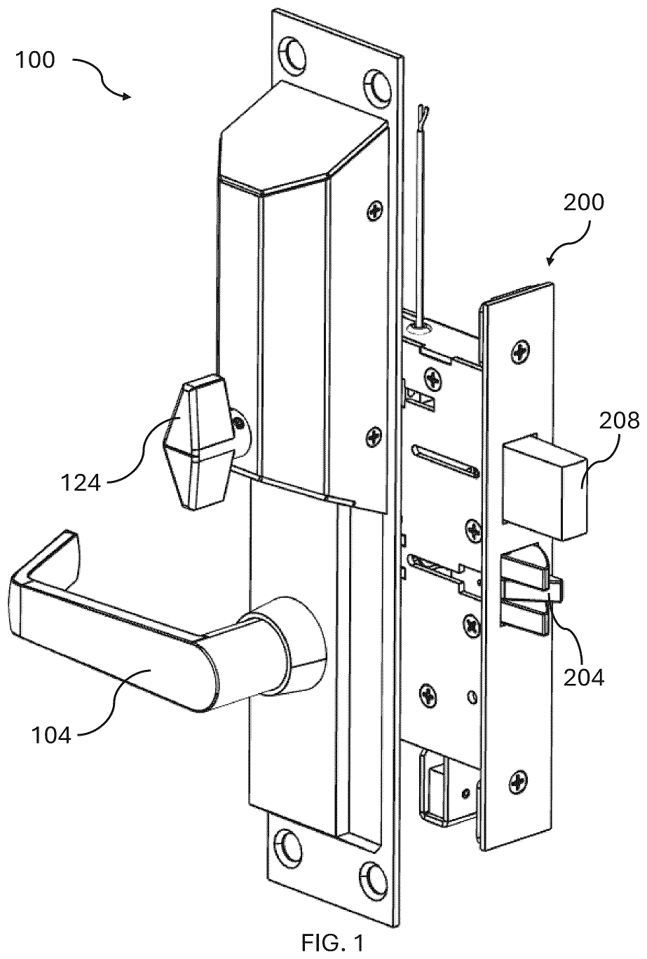

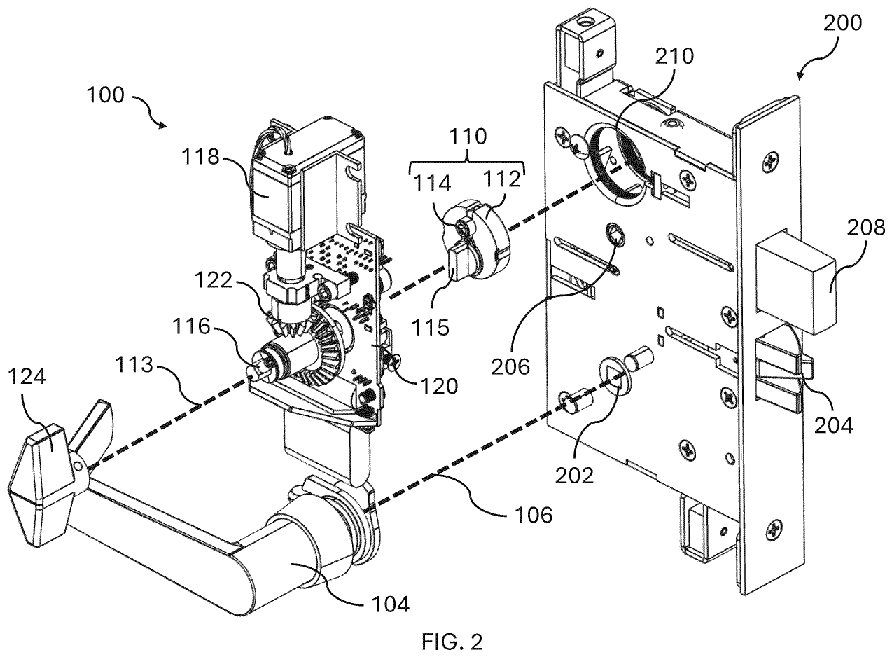

FIG. 1 shows a perspective view of a portion of a door lock system with a lever trim assembly 100 configured to be mounted to an interior/unsecured side of a door coupled to a lock body 200 according to an embodiment. FIG. 2 shows an exploded front perspective view of the lever trim assembly and lock body 200 of FIG. 1 with various housing portions removed.

The lock body 200 may be any suitable conventional lock body which is configured to receive a key cylinder slot, such as the above referenced lock body offered by Securitech Group Inc. In some embodiments, the lock body is a mortise lock body. The lock body 200 may include a latch spindle slot 202 configured to receive a latch spindle (not shown). The latch spindle may be operatively coupled to handle 104, such that rotating the handle 104 about first lock axis 106 rotates the latch spindle. When the latch spindle is received in the latch spindle slot 202, the latch spindle engages with a latch slot linkage (not show) which operatively couples the latch spindle to latch 204, such that rotating the handle 104 about the first lock axis 106 retracts or extends the latch 204.

The lock body 200 may also include a deadbolt spindle slot 206 which is operatively coupled to deadbolt 208 via a deadbolt slot linkage (not shown). The lock body 200 may also include a key cylinder slot 210 which is operatively coupled to both the latch 204 and the deadbolt 208 via a key cylinder slot linkage (not shown).

When lock body 200 is used with conventional lever trim assemblies, the deadbolt slot linkage generally receives a deadbolt spindle, which is operatively coupled to a thumb-turn on the interior/secured conventional lever trim assembly. In this manner, a user on the interior side of the door may rotate the thumb-turn to retract the deadbolt 208, and rotate the handle to retract the latch 204. Additionally, the key cylinder slot 210 would conventionally receive a key cylinder on the exterior/unsecured conventional lever trim assembly which would engage with the key cylinder slot linkage, allowing a user on the exterior/unsecured side of the door to retract the deadbolt 208 and/or the latch 204 and open the door. In some situations, the interior/secured conventional lever trim assembly may also include a key cylinder which is inserted into the key cylinder slot 210 and coupled to the key cylinder slot linkage.

If it is desired to motorize the conventional lever trim assemblies to allow motorized operation of the deadbolt 208 or the latch 204, the typical approach is to couple a motor to the deadbolt spindle, and insert the deadbolt spindle into the deadbolt spindle slot 206. Thus, operating the motor may be used to retract the deadbolt. However, the inventors have recognized that when used with lock bodies where the deadbolt spindle slot 206 is only coupled to the deadbolt 208, such a conventional configuration may not also retract the latch 204. This may be undesirable if, for instance, a user wishes to include an automatic door opener. In such a scenario, because the latch 204 may not be retracted until a user manually operates the handle, the door would not be able to automatically open until a user retracts the latch 204, which negates many if not all of the benefits of automatic door openers.

The inventors have therefore recognized an advantage to providing a key cylinder adapter 110 which is configured to be inserted into the key cylinder slot 210 and engage with the key cylinder linkage of lock body 200 in order to be operatively coupled to both the latch 204 and the deadbolt 208. The key cylinder adapter 110 may include an adapter outer body 112 which is fixed within the key cylinder slot 210, and an adapter linkage 114 rotatably disposed about second lock axis 113 in the adapter outer body 112. The adapter outer body may be fixed within the key cylinder slot using any suitable fastening means. For instance, the key cylinder slot 210 may include a threaded interface, and the adapter outer body 112 may include a corresponding threaded interface, such that the adapter outer body threads into the key cylinder slot 210. However, it is contemplated that any other suitable fastening means, such as press fitting, snap fitting, mechanical fasteners (e.g. screws), adhesives, etc. may be used to fix the adapter outer body 112 within the key cylinder slot 210, as the disclosure is not so limited.

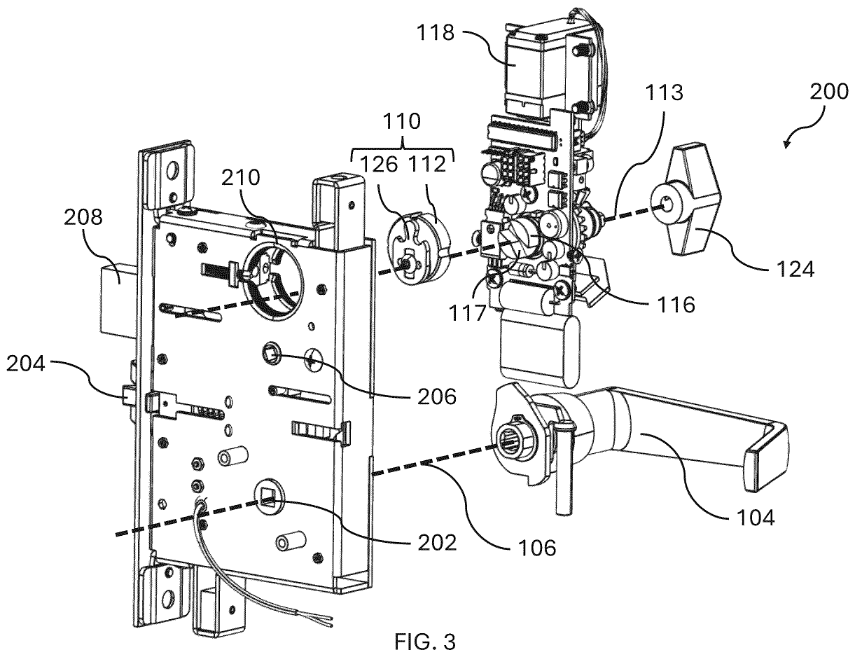

The adapter linkage 114 may be operatively coupled to a key cylinder spindle 116 (See FIG. 3), which itself is operatively coupled to motor 118. In such a configuration, operating motor 118 may actuate the key cylinder spindle 116, thus actuating the adapter linkage 114, which itself actuates the key cylinder linkage in lock body 200 to actuate the deadbolt 208 and/or the latch 204. In this manner, a single motor 118 may be used to extend or retract both the latch 204 and the deadbolt 208 in a lock body such as lock body 200.

Motor 118 may be any suitable motor, such as a stepper motor, a DC motor, etc. Motor 118 may be controlled by a controller 120, which may be any suitable conventional controller. The controller 120 may be configured to communicate with any suitable user interface in order to allow a user to operate the motor 118 to extend or retract the latch 204 and/or the deadbolt 208. For example, the user interface may be an application on a user device (e.g. a smartphone), a biometric reader (e.g. fingerprint reader, retina scanner, etc.), a key card scanner, a keypad, or any other suitable user interface. In some embodiments, the various powered component of the lever trim assembly 100 may be configured to connect to a remote power source (e.g. mains power). However, the inventors have recognized that such a configuration may cause problems in operating the lever trim assembly if the remote power source is unable to deliver electrical power (e.g. due to a power outage, a broken electrical wire, etc.). The inventors have therefore recognized an advantage to disposing at least one supercapacitor in the lever trim assembly and connecting the supercapacitor to the various powered components of the lever trim assembly. During normal operation, the at least one supercapacitor may be charged by the remote power source. If the remote power source becomes unable to deliver electrical power to the various powered components, the supercapacitor(s) may be discharged to supply power to operate the lever trim assembly for a limited number of cycles. In some embodiments, the supercapacitor(s) may only discharge to power the various powered components if a loss of electrical power from the remote power source occurs. In some embodiments, the supercapacitor(s) may discharge to power the various powered components during normal operation, and then be recharged by the remote power source.

In some embodiments, the key cylinder spindle 116 may rotate about the second lock axis 113 when actuated by the motor 118. In some embodiments, the adapter linkage 114 may include a projection 115 configured to interlock with a corresponding receiver slot 117 in the key cylinder spindle 116 (see FIG. 3).

In some embodiments, it may be desirable to minimize the overall thickness of the lever trim assembly 100 in order to improve the overall aesthetics of the lever trim assembly when mounted to a door. However, minimizing such a thickness may be difficult due to size constraints of the motor 118. Generally, a relatively large motor must be used in the lever trim assembly in order to produce a sufficient torque to operate the latch 204 and/or deadbolt 208.

In some embodiments, it may therefore be desirable to position the motor such that the motor shaft 119 extends at a non-parallel angle relative to the second lock axis 113, such as perpendicular to second lock axis 113, and to couple the motor 118 to the key cylinder spindle 116 via bevel gear system 122. Such a configuration may allow the motor 118 to be positioned at a more advantageous orientation in the lever trim assembly 100 to reduce an overall thickness of the lever trim assembly 100, such that the lever trim assembly 100 does not protrude an excessive distance from the door when mounted. In some embodiments, the bevel gear system 122 may be configured to increase the torque applied to the key cylinder spindle 116 by the motor 118 (e.g. by using a larger bevel gear on the key cylinder spindle compared to the motor shaft). Such a configuration may allow for a less powerful motor to be used, potentially decreasing the size and cost of the selected motor.

In some embodiments, the use of bevel gear system 122 may also allow for the connection of a thumb-turn 124 to an end of the key cylinder spindle 116 distal from the lock body 200. In such a configuration the thumb-turn 124 may be disposed more distal from the lock body 200 than the bevel gear system 122 when the lever trim assembly 100 is coupled with the lock body 200. In such a configuration, the motor 118 may be backdriveable in order to allow a user to manually operate the key cylinder spindle 116 via the thumb-turn 124 without interference from the motor 118. In some embodiments, the motor 118 may be backdriveable in order to allow a user to manually operate a key cylinder on the opposite side of the door. While the thumb-turn 124 may be directly connect to the key cylinder spindle 116, it is contemplated that the thumb-turn 124 may be operatively coupled to the key cylinder spindle 116 via any suitable linkage, as the disclosure is not so limited.

While some of the embodiments disclosed above disclose the lever trim assembly 100 including a handle 104 configured to engage with the latch, because both the latch 204 and the deadbolt 208 may be retracted via motor 118, it is contemplated that in some embodiments, the handle 104 may be a fixed handle, such that the fixed handle does not rotate about the first lock axis 106 and is not operatively coupled to the latch 204. Alternatively, the lever trim assembly 100 may not include a handle 104 at all in some embodiments, as the disclosure is not so limited. Additionally, while above embodiments disclose thumb-turn 124 being coupled to the key cylinder spindle 116, it should be understood that, in some embodiments, the lever trim assembly 100 may not include any thumb-turn, as the disclosure is not so limited.

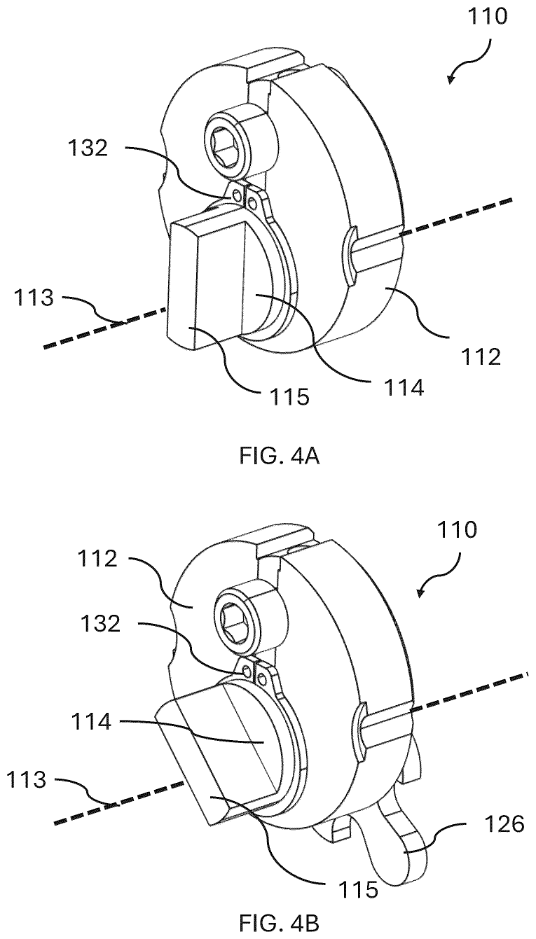

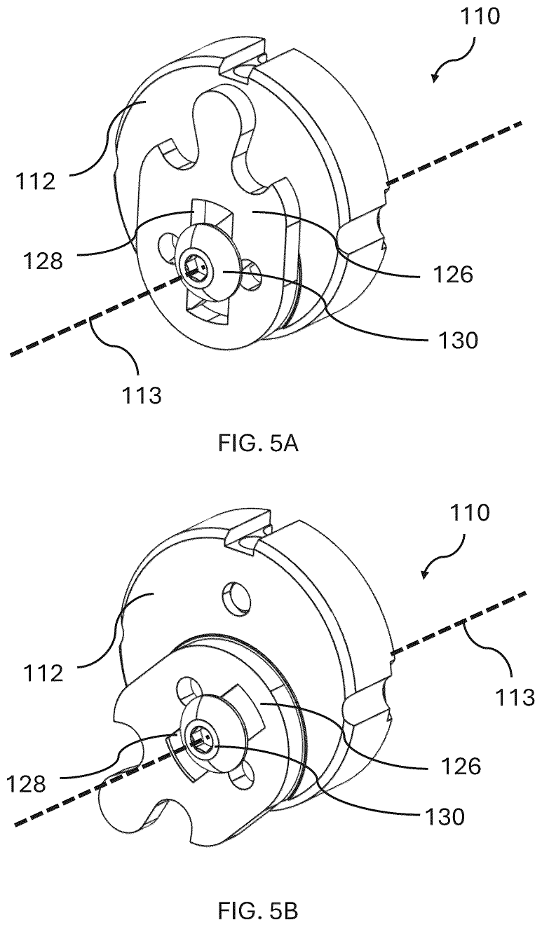

FIGS. 4A and 4B show front perspective views of a key cylinder adapter with components in a first state of rotation about the second lock axis according to an embodiment. FIGS. 5A and 5B show corresponding rear perspective view of the key cylinder adapter with components in a second state of rotation about the second lock axis.

As discussed above, the lever trim assembly 100 may include a key cylinder adapter 110 configured to be received into the key cylinder slot 210 of the lock body 200. Also as mentioned above, the key cylinder adapter 110 may include an adapter outer body 112 configured to be fixed within the key cylinder slot 210, and an adapter linkage configured to rotate within the adapter outer body 112 in order to couple the key cylinder spindle 116 to the key cylinder linkage in the lock body 200.

The inventors have recognized that in order to couple the adapter linkage 114 to such a key cylinder linkage, it may be necessary for a portion of the adapter 110 to extend radially past a perimeter of the key cylinder slot 210 in order to contact and engage the linkage. However, the inventors have also recognized that it may be desirable to ensure that no portion of the key cylinder adapter 110 extends past the perimeter of the key cylinder slot 210 in some configurations. For instance, when the adapter outer body 112 includes a threaded interface configured to thread into the key cylinder slot, no portion of the adapter may extend past the outermost portion of adapter outer body 112 in order for the adapter 110 to fit in the key cylinder slot.

The inventors have therefore recognized an advantage to positioning the adapter linkage 114 offset from the center of the adapter outer body 112 such that the second lock axis 113 is offset from the center of the adapter outer body 112, and attaching a cam portion 126 to the adapter linkage 114. As a result, when the adapter linkage is in the first orientation shown in FIGS. 4A and 5A, the cam portion 126 is disposed wholly within the perimeter if the adapter outer body 112, allowing the key cylinder adapter 110 to be inserted into the key cylinder slot 210. However, as the adapter linkage 114 is rotated about second lock axis 113, as seen in FIGS. 4B and 5B, the cam portion 126 extends past the perimeter of the adapter outer body 112, allowing the cam portion 126 to engage with the key cylinder linkage in the lock body 200.

In some embodiments, the inventors have recognized that it may be desirable for the cam portion 126 to be adjustable, such that users may change the radial distance the cam portion 126 extends past the perimeter of the adapter outer body 112 at a given angle of rotation about the second lock axis 113. Such a configuration may allow the adapter 110 to be used with a wider variety of lock bodies by adjusting how the cam portion 126 engages with the key cylinder linkage. Cam portion 126 may therefore include a slot 128 which is configured to receive a fastener 130 (e.g. a screw), which connects to the adapter linkage 114. To adjust the cam portion 126, a user may loosen the fastener 130, slide the cam portion along slot 128 in a direction approximately perpendicular to the second lock axis 113 to the desired position, and tighten the fastener 130 to hold the cam portion 126 in this position relative to the adapter linkage 114.

In some embodiments, the key cylinder adapter 110 includes a blocker 132 configured to block adapter linkage 114 from sliding towards the lock body 200 along the lock axis 113, and the cam portion 126 blocks the adapter linkage 114 from sliding away from the lock body 200 along the lock axis 113. As a result, the cam portion 126 and blocker 132 both block the adapter linkage 114 from sliding out of the adapter outer body 112, while still allowing for free rotation of the adapter linkage 114 within the adapter outer body 112. Blocker 132 may be integrally formed with the adapter linkage 114, or may be a separate component attached to the adapter linkage 114. For instance, as seen in FIGS. 4A and 4B, the blocker 132 may be a spring ring attached to the adapter linkage 114.

While some embodiments disclosed above disclose the lever trim assembly 100 being coupled to a lock body with a deadbolt, a latch, and a key cylinder linkage coupled to both the latch and the deadbolt, it should be understood that the lever trim assembly 100 may be adapted for use with any lock body with a key cylinder slot and key cylinder linkage, as the disclosure is not so limited. For instance, the lock body could include only one of a latch or a deadbolt which is operatively coupled to a lock cylinder linkage.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

What is claimed is:

1. A lever trim assembly configured to couple to a lock body of a door lock system, the lock body comprising a latch and/or a deadbolt, a key cylinder slot configured to receive a key cylinder, and a key cylinder linkage configured to operatively couple at least one of the latch and/or deadbolt to such a key cylinder, the lever trim assembly comprising:
a key cylinder spindle;
a key cylinder adapter configured to be received into the key cylinder slot and operatively couple the key cylinder spindle to the key cylinder linkage;
a bevel gear system operatively coupled to the key cylinder spindle;
a motor operatively coupled to the bevel gear system to drive the key cylinder spindle; and
a controller configured to control the motor to actuate the bevel gear system, the key cylinder spindle, the key cylinder adapter, and the key cylinder linkage to extend or retract the at least one of the latch and/or the deadbolt.

2. The lever trim assembly of claim 1, wherein the key cylinder spindle is configured to rotate about a lock axis, and wherein an axis of rotation of a motor shaft of the motor is approximately perpendicular to the lock axis.

3. The lever trim assembly of claim 1, wherein the motor and the controller are configured to be connected to a remote power source, and further comprising at least one supercapacitor connected to the controller and the motor and configured to deliver electrical power to the motor and the controller.

4. The lever trim assembly of claim 1, further comprising a thumb-turn operatively coupled to the key cylinder spindle.

5. The lever trim assembly of claim 4, wherein the motor is backdriveable.

6. The lever trim assembly of claim 4, wherein the thumb-turn is directly connected to the key cylinder spindle.

7. The lever trim assembly of claim 6, wherein the thumb-turn is configured to be disposed further from the lock body than the bevel gear system when the lever trim assembly is coupled to the lock body.

8. The lever trim assembly of claim 1, wherein the key cylinder adapter comprises an outer body configured to engage with the key cylinder slot when the lever trim assembly is coupled to the lock body.

9. The lever trim assembly of claim 8, wherein the outer body comprises a threaded interface configured to engage with a corresponding threaded interface of the key cylinder slot.

10. The lever trim assembly of claim 8, wherein the key cylinder adapter comprises an adapter linkage rotatably disposed in the outer body, wherein the adapter linkage is rotatable about a lock axis.

11. The lever trim assembly of claim 10, wherein the key cylinder adapter comprises a cam portion connected to the adapter linkage and configured to operatively couple to the key cylinder linkage.

12. The lever trim assembly of claim 11, wherein the cam portion connects to the adapter linkage via a slot to allow for adjustment of the cam portion in a direction approximately perpendicular to the lock axis.

13. The lever trim assembly of claim 11, wherein the lock axis is offset from a center of the outer body.

14. The lever trim assembly of claim 13, wherein the cam portion is configured to selectively extend past an outer perimeter of the outer body during rotation of the adapter linkage and the cam portion about the lock axis.

15. A door lock system comprising:
a lock body comprising:
a latch and/or a deadbolt;
a key cylinder slot configured to receive a key cylinder; and
a key cylinder linkage configured to operatively couple at least one of the latch and/or deadbolt to such a key cylinder; and
a lever trim assembly configured to couple to the lock body, the lever trim assembly comprising:
a key cylinder spindle;
a key cylinder adapter configured to be received into the key cylinder slot and operatively couple the key cylinder spindle to the key cylinder linkage;
a bevel gear system operatively coupled to the key cylinder spindle;
a motor operatively coupled to the bevel gear system to drive the key cylinder spindle; and
a controller configured to control the motor to actuate the bevel gear system, the key cylinder spindle, the key cylinder adapter, and the key cylinder linkage to extend or retract the at least one of the latch and/or the deadbolt.

16.-21. (canceled)

22. The door lock system of claim 15, wherein the key cylinder adapter comprises an outer body configured to engage with the key cylinder slot when the lever trim assembly is coupled to the lock body.

23. The door lock system of claim 22, wherein the outer body comprises a threaded interface configured to engage with a corresponding threaded interface of the key cylinder slot.

24. The door lock system of claim 22, wherein the key cylinder adapter comprises an adapter linkage rotatably disposed in the outer body, wherein the adapter linkage is rotatable about a lock axis.

25. The door lock system of claim 24, wherein the key cylinder adapter comprises a cam portion connected to the adapter linkage and configured to operatively couple to the key cylinder linkage.

26. The door lock system of claim 25, wherein the cam portion connects to the adapter linkage via a slot to allow for adjustment of the cam portion in a direction approximately perpendicular to the lock axis.

27.-29. (canceled)
